(19) United States
(12) Patent Application Publication
(10) Pub. No.: US 2025/0258537 A1
(43) Pub. Date: Aug. 14, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventors: QI WANG, TOKYO (JP); YASUTAKA FUKUMOTO, TOKYO (JP); YUKI TANAKA, TOKYO (JP); KEITA MOCHIZUKI, TOKYO (JP)

(21) Appl. No.: 18/856,672

(22) PCT Filed: Mar. 2, 2023
(86) PCT No.: PCT/JP2023/007825

§ 371 Date: Oct. 14, 2024

(30) Foreign Application Priority Data
Apr. 22, 2022 (JP) 2022-070981

(51) Int. Cl. G06F 3/01

(52) U.S. Cl. CPC G06F 3/011

(57) ABSTRACT

To reutilize motion data.

An information processing apparatus, including: an acquiring unit configured to acquire a motion data group indicating time-series data of motion of a user; an imparting unit configured to impart meta-information related to a basic movement in association with motion data with respect to the motion data group acquired by the acquiring unit; and a replacing unit configured to replace the motion data associated with the meta-information corresponding to a designated section indicating a section designated by the user among the motion data group with reference motion data to be a reference.

### TECHNICAL FIELD

The present disclosure relates to an information processing apparatus, an information processing method, and a program.

### BACKGROUND ART

In recent years, animation utilizing motion capture for acquiring motion information indicating motion of a user has been vigorously produced and distributed. For example, it is common practice to generate motion data that simulates motion of the user using acquired motion information and distribute an avatar video based on the motion data. Against such a background, more and more motion data is being generated year after year and techniques for reutilizing previously-generated motion data are being developed.

For example, NPL 1 below discloses a technique of generating three-dimensional dance motion from music and basic movements.

### CITATION LIST

### Non Patent Literature

### NPL 1

Ruilong Li, et al., “AI Choreographer: Music Conditioned 3D Dance Generation with AIST++”, ICCV paper, [Online], [retrieved Mar. 24, 2021], <https://openaccess.thecvf.com/content/ICCV2021/papers/Li_AI_Choreographer_Music_Conditioned_3D_Dance_Generation_With_AIST_ICCV_2021_paper.pdf>

### SUMMARY

### Technical Problem

However, with NPL 1 described above, it is difficult to reutilize previously generated motion data such as replacing a movement of the user with previously generated motion data.

In consideration thereof, the present disclosure proposes a novel and improved information processing apparatus, information processing method, and program that enable motion data to be reutilized.

### Solution to Problem

The present disclosure provides an information processing apparatus including: an acquiring unit configured to acquire a motion data group indicating time-series data of motion of a user; an imparting unit configured to impart meta-information related to a basic movement in association with motion data with respect to the motion data group acquired by the acquiring unit; and a replacing unit configured to replace the motion data associated with the meta-information corresponding to a designated section indicating a section designated by the user among the motion data group with reference motion data to be a reference.

In addition, the present disclosure provides an information processing method executed by a computer, including the steps of: acquiring a motion data group indicating time-series data of motion of a user; imparting meta-information related to a basic movement in association with motion data with respect to the acquired motion data group; and replacing the motion data associated with the meta-information corresponding to a designated section indicating a section designated by the user among the motion data group with reference motion data to be a reference.

Furthermore, the present disclosure provides a program causing a computer to realize: an acquiring function of acquiring a motion data group indicating time-series data of motion of a user; an imparting function of imparting meta-information related to a basic movement in association with motion data with respect to the motion data group acquired by the acquiring function; and a replacing function of replacing the motion data associated with the meta-information corresponding to a designated section indicating a section designated by the user among the motion data group with reference motion data to be a reference.

### BRIEF DESCRIPTION OF DRAWINGS

FIG. 1 is an explanatory diagram showing an information processing system according to an embodiment of the present disclosure.

FIG. 2 is an explanatory diagram for describing a functional configuration example of an information processing terminal 10 according to the present disclosure.

FIG. 3 is an explanatory diagram for describing a functional configuration example of a server 20 according to the present disclosure.

FIG. 4 is an explanatory diagram showing a specific example of a generation method of skeleton data.

FIG. 5 is an explanatory diagram for describing an example of a method of learning a relationship between time-series data of skeleton data and a preprocessing feature amount using a machine learning technique.

FIG. 6 is an explanatory diagram for describing an example of a method of calculating a preprocessing feature amount for each region according to the present disclosure.

FIG. 7 is an explanatory diagram for describing an example of a method of calculating a post-processing parameter by applying a weighting parameter to a preprocessing feature amount.

FIG. 8 is an explanatory diagram for describing an example of a weighting parameter prepared for each time.

FIG. 9 is an explanatory diagram for describing an example of a learning method of a weighting parameter.

FIG. 10 is an explanatory diagram for describing an example of processing of correcting a feature amount of motion data.

FIG. 11 is an explanatory diagram for describing an example of a data collection screen D1.

FIG. 12 is an explanatory diagram for describing an example of an upload screen D2.

FIG. 13 is an explanatory diagram for describing an example of a record screen D3.

FIG. 14 is an explanatory diagram for describing an example of a confirmation screen D4.

FIG. 15 is an explanatory diagram for describing an example of a result display screen D5.

FIG. 16 is an explanatory diagram for describing an example of a plurality of sections divided by a dividing unit.

FIG. 17 is an explanatory diagram for describing another example of the result display screen D5.

FIG. 18 is an explanatory diagram for describing another example of the result display screen D5.

FIG. 19 is an explanatory diagram for describing an example of the result display screen D5 according to a third example.

FIG. 20 is an explanatory diagram for describing an example of a setting screen D6 for a presentation method to a user.

FIG. 21 is an explanatory diagram for describing an example of a practice screen 7 that is displayed when a real-time practice button B10 is selected by a user.

FIG. 22 is an explanatory diagram for describing an example of a manual screen for manually designating a designated section.

FIG. 23 is an explanatory diagram for describing an example of a candidate display screen of reference motion data.

FIG. 24 is an explanatory diagram for describing an operation processing example related to replacing motion data of the information processing terminal 10 according to the present disclosure.

FIG. 25 is an explanatory diagram for describing an operation processing example related to retrieving motion data of the server 20 according to the present disclosure.

FIG. 26 is a block diagram showing a hardware configuration of the information processing terminal 10.

### DESCRIPTION OF EMBODIMENTS

A preferred embodiment of the present disclosure will be hereinafter described in detail with reference to the accompanying drawings. In the present specification and the drawings, components having substantially a same functional configuration will be denoted by same reference numerals and repeated descriptions thereof will be omitted.

In addition, “Description of Embodiments” will be described in accordance with the following order of items.
1. Overview of information processing system
2. Functional configuration examples
2-1. Functional configuration example of information processing terminal
2-2. Functional configuration example of server
3. Details
3-1. Posture estimation
3-2. Feature amount calculation
3-3. Weighting parameter
3-4. Similarity evaluation
3-5. Correction
4. User interface
4-1. First example
4-2. Second example
4-3. Third example
4-4. Fourth example
4-5. Fifth example
5. Operation examples
5-1. Operation example of information processing terminal
5-2. Operation example of server
6. Hardware configuration example
7. Supplements

### 1. OVERVIEW OF INFORMATION PROCESSING SYSTEM

In order to visualize information on motion of a moving body such as a person or an animal, skeleton data that is represented by a skeleton structure indicating, for example, a bodily structure is used as motion data. Skeleton data includes information on a position, a posture, and the like of regions. More specifically, skeleton data includes various kinds of information such as a global position of a root joint and a relative posture and the like of each joint. A region in a skeleton structure corresponds to, for example, a distal region, a joint region, or the like of a body. In addition, skeleton data may include a bone that is a line segment connecting regions to each other. While a bone in a skeleton structure may correspond to, for example, a bone in a human body, positions and numbers of bones need not necessarily be consistent with an actual human skeleton.

A position and a posture of each region in skeleton data can be acquired using various motion capture techniques. For example, there are a camera-type technique involving mounting a marker to each region of a body and acquiring a position of the marker using an external camera or the like and a sensor-based technique involving mounting a motion sensor to a region of a body and acquiring positional information of the motion sensor based on time-series data acquired by the motion sensor.

In addition, skeleton data is used in a wide variety of applications. For example, time-series data of skeleton data is used to improve mechanics in dancing or sports or used in applications such as VR (Virtual Reality) and AR (Augmented Reality). Furthermore, it is common practice to generate an avatar video simulating motion of a user using motion data that is time-series data of skeleton data and to distribute the avatar video.

Note that motion data may further include skeleton information indicating a length of each bone and a connection relationship between the bone and another bone and various kinds of information such as time-series data of ground contact information of both feet.

Hereinafter, a configuration example of an information processing system which acquires time-series data of motion of a user and which replaces a basic movement of the user included in the time-series data with reference motion data to be a reference of the basic movement will be described as an embodiment of the present disclosure.

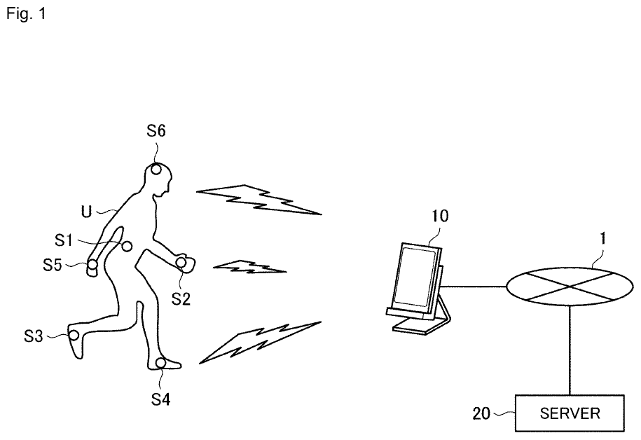

FIG. 1 is an explanatory diagram showing an information processing system according to an embodiment of the present disclosure. As shown in FIG. 1, the information processing system according to the embodiment of the present disclosure includes six sensor apparatuses S1 to S6 to be mounted to a user U, an information processing terminal 10, and a server 20.

The information processing terminal 10 and the server 20 are connected via a network 1. The network 1 is a wired or wireless transmission line for information transmitted from apparatuses connected to the network 1. For example, the network 1 may include public networks such as the Internet, a telephone network, and a satellite communication network, various LANs (Local Area Networks) including Ethernet (registered trademark), and a WAN (Wide Area Network). Moreover, the network 1 may include leased line networks such as an IP-VPN (Internet Protocol-Virtual Private Network).

### Sensor Apparatus S

A sensor apparatus S detects motion of the user U. For example, the sensor apparatus S may be an apparatus mounted with an inertial sensor (IMU: Inertial Measurement Unit) such as an acceleration sensor that acquires acceleration or a gyroscope sensor (angular velocity sensor) that acquires angular velocity.

Alternatively, the sensor apparatus S may be an apparatus mounted with a sensor that detects motion of the user U such as an imaging sensor, a ToF (Time of Flight) sensor, a magnetic sensor, or an ultrasonic sensor.

The sensor apparatuses S1 to S6 are desirably mounted to joint regions (for example, the waist or the head) as references of the body or in the vicinity of distal ends of the body (wrists, ankles, or the head). In the example shown in FIG. 1, the sensor apparatus S1 is mounted to the hip, the sensor apparatuses S2 and S5 are mounted to both wrists, the sensor apparatuses S3 and S4 are mounted to both ankles, and the sensor apparatus S6 is mounted to the head of the user U. Hereinafter, a region of the body to which the sensor apparatus S is mounted may also be referred to as a mounted region. In addition, the number and mounting positions (positions of the mounted regions) of the sensor apparatuses S are not limited to the example shown in FIG. 1 the number of the sensor apparatuses S mounted to the user U may be more or may be less.

The sensor apparatus S acquires acceleration or an angular velocity of the mounted region as time-series data and transmits the time-series data to the information processing terminal 10.

Alternatively, the user U need not be mounted with the sensor apparatus S. For example, the information processing terminal 10 may detect motion of the user U using various sensors (for example, an imaging sensor and a ToF sensor) included in the information processing terminal 10.

### Information Processing Terminal 10

The information processing terminal 10 is an example of the information processing apparatus. The information processing terminal 10 acquires time-series data of motion of the user from the sensor apparatus S. In the following description, time-series data of motion of the user may be expressed as a motion data group.

In addition, with respect to a motion data group received from the sensor apparatus S, the information processing terminal 10 imparts meta-information related to a basic movement in association with motion data.

Furthermore, the information processing terminal 10 replaces the motion data associated with meta-information corresponding to a designated section indicating a section designated by the user U with reference motion data to be a reference.

While FIG. 1 shows a smartphone as the information processing terminal 10, the information processing terminal 10 may be another apparatus such as a notebook PC (Personal Computer) or a desktop PC.

### Server 20

The server 20 holds a plurality of pieces of motion data and a feature amount of each of the plurality of pieces of motion data. In addition, the server 20 performs a similarity evaluation of each feature amount of the plurality of pieces of motion data and a post-processing feature amount received from the information processing terminal 10 and transmits motion data in accordance with a result of the similarity evaluation to the information processing terminal 10.

This concludes the description of an overview of the information processing system according to the present disclosure. Next, functional configuration examples of the information processing terminal 10 and the server 20 according to the present disclosure will be described.

### 2. FUNCTIONAL CONFIGURATION EXAMPLES

### 2-1. Functional Configuration Example of Information Processing Terminal

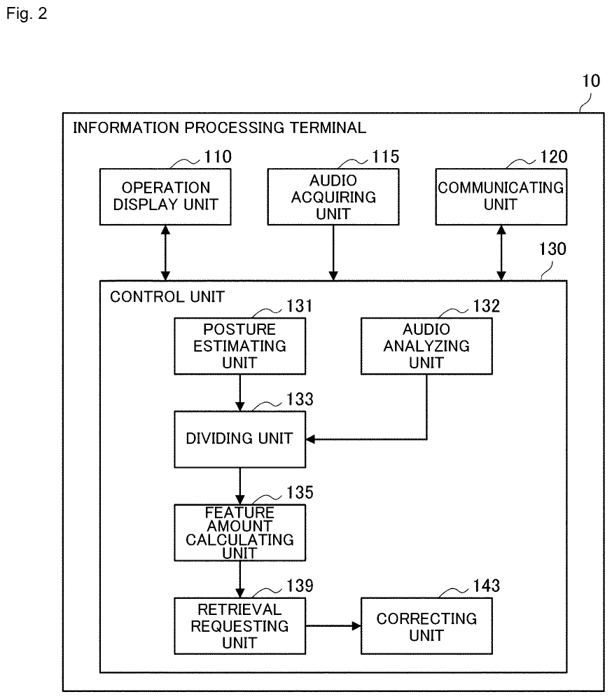

FIG. 2 is an explanatory diagram for describing a functional configuration example of the information processing terminal 10 according to the present disclosure. As shown in FIG. 2, the information processing terminal 10 includes an operation display unit 110, an audio acquiring unit 115, a communicating unit 120, and a control unit 130.

### Operation Display Unit 110

The operation display unit 110 has a function as a display unit that displays a retrieval result transmitted by the server 20. For example, the operation display unit 110 displays reference motion data transmitted by the server 20.

In addition, the operation display unit 110 has a function as an operating unit to be used by a user to input operations.

The function as the display unit is implemented by, for example, a CRT (Cathode Ray Tube) display apparatus, a liquid crystal display (LCD) apparatus, or an OLED (Organic Light Emitting Diode) apparatus.

In addition, the function as the operating unit is implemented by, for example, a touch panel, a keyboard, or a mouse.

While FIG. 1 shows the information processing terminal 10 being configured such that functions of the display unit and the operating unit are integrated, the information processing terminal 10 may be configured such that functions of the display unit and the operating unit are separated.

### Audio Acquiring Unit 115

The audio acquiring unit 115 acquires audio. For example, the function of the audio acquiring unit 115 is implemented by a microphone.

### Communicating Unit 120

The communicating unit 120 communicates various kinds of information with the server 20 via the network 1. For example, the communicating unit 120 is an example of the acquiring unit and receives time-series data of motion of the user from the sensor apparatus S. For example, the communicating unit 120 may receive time-series data of motion of the user who moves to some kind of music.

In addition, the communicating unit 120 transmits post-processing feature amount of skeleton data calculated from the time-series data of the motion of the user to the server 20. Furthermore, the communicating unit 120 receives reference motion data retrieved by the server 20 in response to the transmitted post-processing feature amount.

### Control Unit 130

The control unit 130 controls overall operations of the information processing terminal 10. As shown in FIG. 2, the control unit 130 includes a posture estimating unit 131, an audio analyzing unit 132, a dividing unit 133, a feature amount calculating unit 135, a retrieval requesting unit 139, and a correcting unit 143.

The posture estimating unit 131 estimates mounted region information indicating a position and a posture of each mounted region based on time-series data of acceleration, a velocity, or the like of the mounted region acquired from the sensor apparatus S. Note that the position and the posture of each mounted region may be a two-dimensional position or a three-dimensional position.

In addition, based on mounted region information, the posture estimating unit 131 generates skeleton data including positional information and posture information of each region in a skeleton structure. Furthermore, the posture estimating unit 131 may convert the generated skeleton data into reference skeleton data. Details of posture estimation will be described later.

The audio analyzing unit 132 is an example of the acquiring unit and acquires music information indicating information related to music based on audio acquired by the audio acquiring unit.

For example, music information includes various kinds of information related to music such as a rhythm of music (for example, a sounding pattern), a tempo of music (for example, a playback speed of a song), and a song title. More specifically, music information may include BPM (Beats Per Minute) as an example of a tempo of music.

The dividing unit 133 is an example of the imparting unit and imparts, with respect to an acquired motion data group, meta-information related to a basic movement in association with motion data. For example, based on the imparted meta-information, the dividing unit 133 may divide the motion data group into a plurality of sections corresponding to motion data associated with the basic movement.

For example, the dividing unit 133 may impart meta-information based on the mounted region information estimated by the posture estimating unit 131 and divide the motion data group into sections for each basic movement based on the imparted meta-information.

In addition, the dividing unit 133 may impart meta-information based on the music information obtained by the audio analyzing unit 132 and divide the motion data group into a plurality of sections based on the imparted meta-information.

Furthermore, the dividing unit 133 may impart meta-information based on the mounted region information and the music information and divide the motion data group into a plurality of sections based on the imparted meta-information.

The feature amount calculating unit 135 calculates a preprocessing feature amount that is a feature amount of an entire body or a feature amount of each region of skeleton data from time-series data of the skeleton data.

For example, the feature amount calculating unit 135 may calculate a preprocessing feature amount of each section of time-series data divided by the dividing unit 133. In addition, the feature amount calculating unit 135 may calculate a preprocessing feature amount of a designated section indicating a section designated by the user among respective sections of the time-series data divided by the dividing unit 133.

In addition, the feature amount calculating unit 135 may apply a weighting parameter to a preprocessing feature amount to calculate a post-processing feature amount. Details of the preprocessing feature amount, the weighting parameter, and the post-processing feature amount will be described later.

The retrieval requesting unit 139 causes the post-processing feature amount calculated by the feature amount calculating unit 135 to be transmitted to the communicating unit 120 as a retrieval request.

For example, the retrieval requesting unit 139 causes a post-processing feature amount of a motion of the user performing a basic movement that is included in a designated section indicating a section designated by the user among sections including the basic movement having been divided by the dividing unit 133 to be transmitted to the communicating unit 120 as a retrieval request.

In addition, the retrieval requesting unit 139 is an example of the replacing unit and replaces motion data associated with meta-information corresponding to the designated section with reference motion data to be a reference of the basic movement.

The correcting unit 143 corrects a feature amount of motion data received as a retrieval result from the server 20 by mixing the post-processing feature amount with the feature amount of the motion data at a set ratio. Details of correction will be described in detail later.

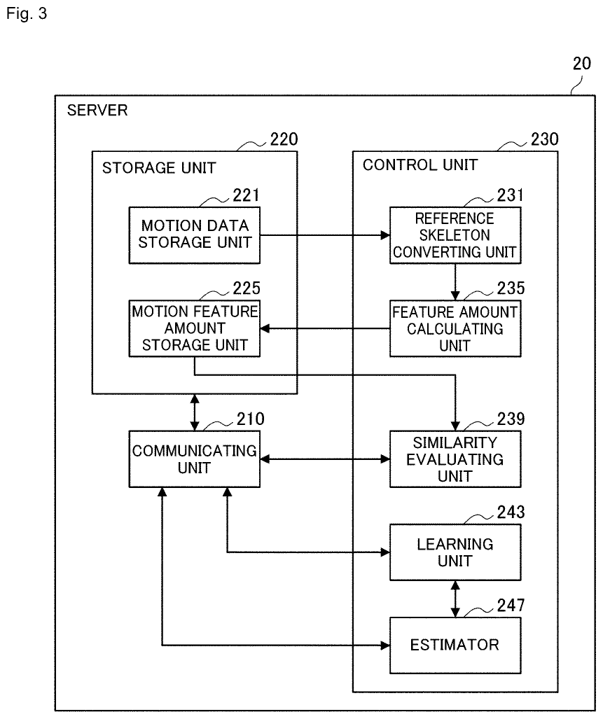

This concludes the description of a functional configuration example of the information processing terminal 10. Next, a functional configuration example of the server 20 will be described with reference to FIG. 3.

### 2-2. Functional Configuration Example of Server

FIG. 3 is an explanatory diagram for describing a functional configuration example of the server 20 according to the present disclosure. As shown in FIG. 3, the server 20 includes a communicating unit 210, a storage unit 220, and a control unit 230.

### Communicating Unit 210

The communicating unit 210 communicates various kinds of information with the information processing terminal 10 via the network 1. For example, the communicating unit 210 receives a post-processing feature amount of the entire body or each region of skeleton data calculated from time-series data of motion of the user from the information processing terminal 10.

In addition, the communicating unit 210 transmits motion data retrieved in response to the post-processing feature amount received from the information processing terminal 10 to the information processing terminal 10.

### Storage Unit 220

The storage unit 220 holds software and various kinds of data. As shown in FIG. 3, the storage unit 220 includes a motion data storage unit 221 and a motion feature amount storage unit 225.

The motion data storage unit 221 holds a plurality of pieces of motion data. For example, the motion data storage unit 221 holds reference motion data to be a reference of a basic movement.

For example, the motion data storage unit 221 holds reference motion data obtained when a user with a high degree of proficiency in dancing performs a basic movement. In the following description, reference motion data may be simply expressed as motion data.

The motion feature amount storage unit 225 stores a feature amount of each of a plurality of pieces of motion data held in the motion data storage unit 221. In addition, the motion feature amount storage unit 225 may hold a feature amount of reference motion data that is motion data in which each piece of skeleton data included in the motion data has been converted to reference skeleton data.

### Control Unit 230

The control unit 230 performs control related to overall operations of the server 20. As shown in FIG. 3, the control unit 230 includes a reference skeleton converting unit 231, a feature amount calculating unit 235, a similarity evaluating unit 239, a learning unit 243, and an estimator 247.

The reference skeleton converting unit 231 converts skeleton data included in each of the plurality of pieces of motion data into reference skeleton data. More specifically, the reference skeleton converting unit 231 executes normalization processing of converting a skeleton of each region included in each piece of skeleton data into a reference skeleton that includes predetermined skeleton information.

The feature amount calculating unit 235 calculates a feature amount of motion data having been converted into reference skeleton data and outputs a calculation result of the feature amount to the motion feature amount storage unit 225. Note that motion data having been converted into reference skeleton data is an example of reference motion data.

The similarity evaluating unit 239 evaluates a similarity between the post-processing feature amount received from the information processing terminal 10 and a feature amount of each of a plurality of pieces of motion data held in the motion feature amount storage unit 225. Details of similarity evaluation will be described later.

The learning unit 243 generates learning data using a machine learning technique that uses a set of time-series data of each region of skeleton data and a feature amount of each region of motion data as training data.

In addition, by using attention in the machine learning technique that uses a set of time-series data of skeleton data and a feature amount of each region of motion data as training data, the learning unit 243 may acquire a weighting parameter per region or a weighting parameter per time.

The estimator 247 estimates a preprocessing feature amount of each region from skeleton data of the user. Functions of the estimator 247 are obtained by learning data generated by the learning unit 243.

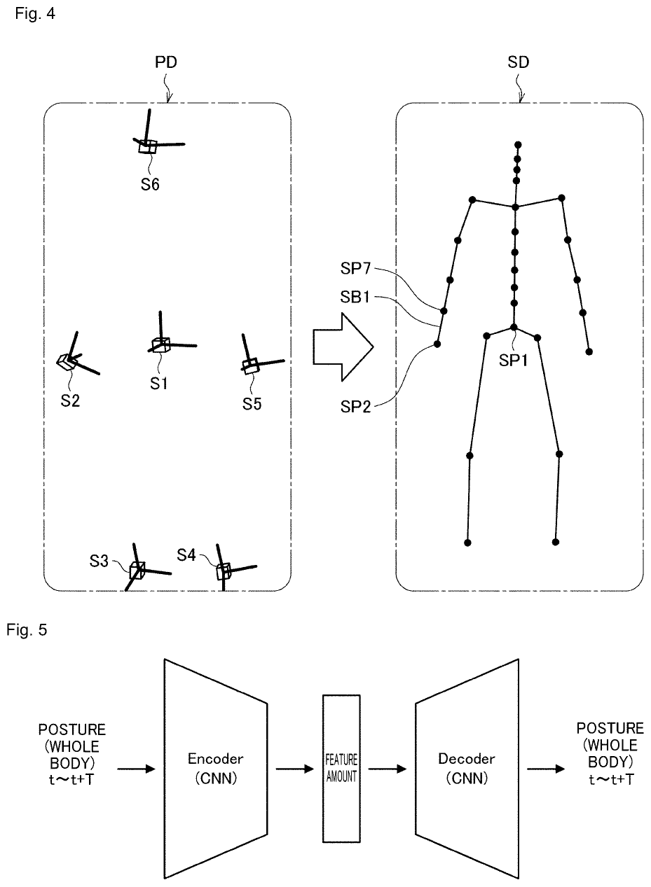

This concludes the description of functional configuration examples according to the present disclosure. Next, details of processing according to the present disclosure will be described in sequence with reference to FIGS. 4 to 10.

### 3. DETAILS

### 3-1. Posture Estimation

FIG. 4 is an explanatory diagram showing a specific example of a generation method of skeleton data. Based on time-series data, the posture estimating unit 131 acquires mounted region information PD including positional information and posture information of mounted regions where the sensor apparatuses S1 to S6 are mounted as shown in a left diagram in FIG. 4.

Furthermore, based on the mounted region information PD of mounted regions, the posture estimating unit 131 acquires skeleton data SD including positional information and posture information of each region in a skeleton structure as shown in a right diagram in FIG. 4. The skeleton data SD includes not only information on a mounted region SP1 that corresponds to the mounted region of the sensor apparatus S1 and a mounted region SP2 that corresponds to the mounted region of the sensor apparatus S2 but also includes information on a non-mounted region SP7.

Note that the skeleton data SD may include information (positional information, posture information, and the like) on bones in addition to information on regions. For example, in the example shown in FIG. 4, the skeleton data SD may include information on a bone SB1. The posture estimating unit 131 can specify information on a bone between regions based on positional information and posture information on the regions in the skeleton structure.

In addition, motion of the user may be detected using an imaging sensor or a ToF sensor included in the information processing terminal 10. In this case, the posture estimating unit 131 may generate skeleton data SD of the user using, for example, an estimator obtained by a machine learning technique that uses a set of time-series data of an image acquired by photographing a person and skeleton data as training data.

Furthermore, although details will be provided later, when performing a similarity evaluation of the post-processing feature amount calculated from time-series data of skeleton data SD generated based on mounted region information and a feature amount of each of the plurality of pieces of motion data held by the motion data storage unit 221, there may be cases where each piece of skeleton data is favorably converted into a same piece of skeleton information (bone length, bone thickness, and the like).

In consideration thereof, the posture estimating unit 131 may convert a skeleton of each region of skeleton data SD into a reference skeleton and convert skeleton data SD into reference skeleton data. However, when a similarity evaluation based on feature amounts not dependent on skeletons is to be performed, the posture estimating unit 131 need not convert the skeleton data SD into reference skeleton data. For example, a feature amount not dependent on a skeleton includes posture information of each region.

The posture estimating unit 131 may convert the skeleton data SD into reference skeleton data using, for example, any method. For example, any method includes copying a posture of each joint, scaling a root position according to body height, and adjusting a distal end position of each region using IK (Inverse Kinematics).

In addition, the learning unit 243 included in the server 20 may performing learning for separating skeleton information of skeleton data and motion information from each other using a DNN (Deep Neural Network). By using the estimator 247 obtained by learning, the posture estimating unit 131 may omit processing of converting the skeleton data SD into reference skeleton data. In the following description, reference skeleton data may be simply expressed as skeleton data.

### 3-2. Feature Amount Calculation

In the present disclosure, feature amounts will be described by dividing into two types, namely, a preprocessing feature amount and a post-processing feature amount obtained by applying a weighting parameter (to be described later) to the preprocessing feature amount. However, a feature amount according to the present disclosure need not necessarily be calculated up to a post-processing feature amount. In other words, a feature amount according to the present disclosure may be limited to a preprocessing feature amount.

The feature amount calculating unit 135 calculates a preprocessing feature amount from time-series data of skeleton data estimated by the posture estimating unit 131.

For example, the preprocessing feature amount may be a speed, a position, or a posture (such as rotation) of each joint portion or ground contact information.

In addition, the learning unit 243 may learn a relationship between time-series data of skeleton data and a preprocessing feature amount using a machine learning technique such as DNN. In this case, the feature amount calculating unit 135 calculates a preprocessing feature amount using the estimator 247 obtained by learning. Hereinafter, an example of a method of learning a relationship between time-series data of skeleton data and a preprocessing feature amount using a machine learning technique will be described with reference to FIG. 5.

FIG. 5 is an explanatory diagram for describing an example of a method of learning a relationship between time-series data of skeleton data and a preprocessing feature amount using a machine learning technique. For example, the learning unit 243 may learn a relationship between time-series data of skeleton data and a preprocessing feature amount using an Encoder-Decoder Model.

For example, when posture information of the entire body of skeleton data in time sections t to t+T is used as input, the learning unit 243 estimates a preprocessing feature amount using a CNN (Convolutional Neural Network) as an encoder. In addition, the learning unit 243 outputs a posture of the entire body of skeleton data in time sections t to t+T using CNN as a decoder with respect to the estimated preprocessing feature amount.

While FIG. 5 shows an example of inputting a posture of an entire body as time-series data of skeleton data, for example, the input may be other information related to motion such as a position or a speed of a joint or a plurality of pieces of information may be used as input.

In addition, the input may include music information analyzed by the audio analyzing unit 132.

Furthermore, a structure of the Encoder-Decoder Model according to the present disclosure may be made more multi-layered or more complex or another machine learning technique such as an RNN (Recurrent Neural Network) may be used.

In addition, the learning unit 243 may learn a relationship between time-series data of skeleton data and a preprocessing feature amount using Deep Metric Learning. For example, the learning unit 243 may learn a relationship between time-series data of skeleton data and a preprocessing feature amount using Triplet Loss.

When using Triplet Loss, data (positive data) that is similar to a given input (anchor) and data (negative data) that is dissimilar to the anchor may be artificially used or a similarity evaluation method of time-series data may be used. Alternatively, temporally close data may be assumed to be similar data and temporally distant data may be assumed to be dissimilar data. For example, methods of similarity evaluation of time-series data include DTW (Dynamic Time Warping).

In addition, information such as a class label (for example, a step or a kick) may be attached to a data set to be learned. When information on a class label is attached to a data set to be learned, an intermediate feature amount to be subjected to class classification may be used as a preprocessing feature amount. Furthermore, when a class label is to be attached to a part of a data set to be learned, learning may be performed using a machine learning technique based on semi-supervised learning that combines an Encoder-Decoder Model with Triplet Loss.

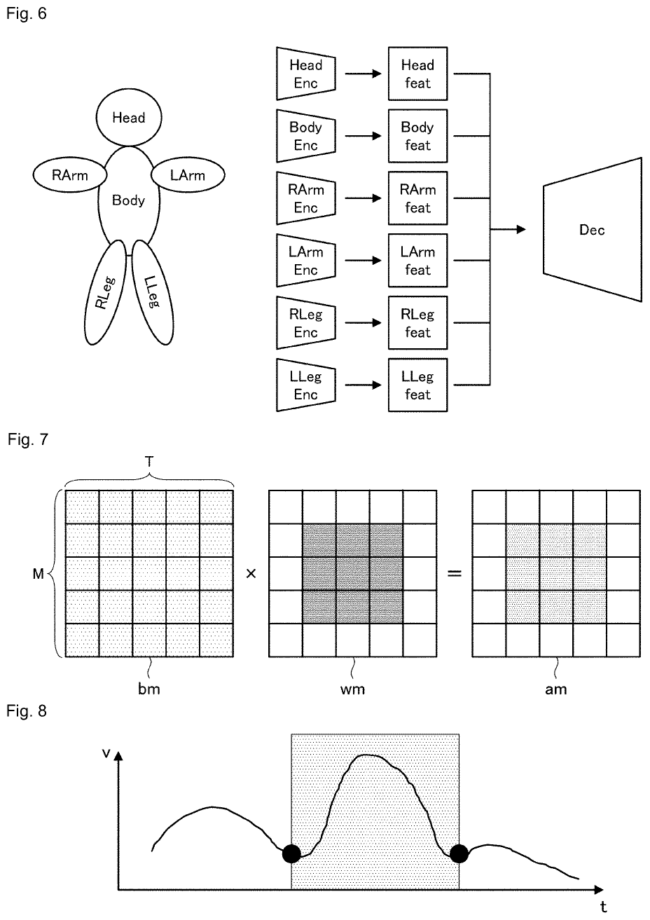

FIG. 6 is an explanatory diagram for describing an example of a method of calculating a preprocessing feature amount for each region according to the present disclosure.

As shown in FIG. 6, when regions included in an entire body are divided into the five regions of the head (Head), the body (Body), the right arm (RArm), the left arm (LArm), the right leg (RLeg), and the left leg (LLeg), the learning unit 243 may learn a relationship between time-series data of each region of skeleton data and each preprocessing feature amount using a DNN for each region of the skeleton data.

For example, the learning unit 243 inputs a posture of the body of skeleton data in time sections t to t+T and, using a DNN as an encoder, estimates a preprocessing feature amount of the body of skeleton data.

In addition, the learning unit 243 outputs a posture of the entire body of skeleton data in time sections t to t+T by using the DNN as a decoder with respect to the calculated preprocessing feature amount of each region to integrate the preprocessing feature amounts of the respective regions.

This concludes the description of a specific example of inputs and learning methods of a preprocessing feature amount. Note that the learning unit 243 may learn a relationship between input and a preprocessing feature amount by combining the plurality of learning methods of a preprocessing feature amount described above.

### 3-3. Weighting Parameter

In the present disclosure, when retrieving motion data, a user performs a movement related to the retrieval of the motion data. In addition, the feature amount calculating unit 135 calculates a feature amount for each designated section from time-series data of skeleton data that indicates motion of the user. Furthermore, the feature amount calculating unit 135 may calculate a feature amount for each predetermined time section included in a designated section from time-series data of skeleton data that indicates motion of the user.

In addition, the feature amount calculating unit 135 may calculate a preprocessing feature amount of each region of the skeleton data indicating motion of the user. For example, when the user performs a movement of a kick, the feature amount calculating unit 135 not only calculates a preprocessing feature amount of a leg kicked up by the user but also a preprocessing feature amount of each region such as the head and the arms.

However, when retrieving motion data, there may be cases where feature amounts of all time sections or feature amounts of all regions are not necessarily important. In consideration thereof, the feature amount calculating unit 135 according to the present disclosure may calculate a post-processing feature amount by applying a weighting parameter prepared for each time or each region to a preprocessing feature amount for each time or for each region calculated from time-series data of motion of skeleton data.

FIG. 7 is an explanatory diagram for describing an example of a method of calculating a post-processing parameter by applying a weighting parameter to a preprocessing feature amount. As shown in FIG. 7, the feature amount calculating unit 135 calculates a post-processing feature amount am by respectively applying a weighting parameter wm with respect to each dimension or each time of a preprocessing feature amount bm of one region j.

The preprocessing feature amount bm of the region j may be represented by a determinant expressed as bm^{j}∈R^{M×T}, where M denotes the number of dimensions in a feature amount direction and T denotes the number of predetermined time sections having been divided in a time direction. In other words, FIG. 7 shows an example where the number of dimensions M in a feature amount direction and the number of predetermined time sections T in a time direction are both 5. Note that the number of dimensions M in a feature amount direction may be a single dimension or a plurality of dimensions. In addition, the weighting parameter wm and the post-processing feature amount am are also represented by the same number of rows and the same number of columns as the preprocessing feature amount bm.

In addition, in FIG. 7, a magnitude of each feature amount included in the preprocessing feature amount, each parameter included in the weighting parameter, and each feature amount included in the post-processing feature amount are represented by shades of color. Although, in FIG. 7, shading of each feature amount included in the preprocessing feature amount bm is represented by one value and shading of each parameter included in the weighting parameter wm and each feature amount included in the post-processing feature amount am are represented by two values, the shading may include various values.

Furthermore, when there are a plurality of regions, the other regions may be concatenated in a feature amount direction. For example, when the number of regions is N, the weighting parameter wm is represented by a determinant expressed as wm∈R^{(M×N)×T}.

The weighting parameter wm may be set on an UI by the user or may be determined using the estimator 247 obtained by a machine learning technique. First, an example where the weighting parameter is set by the user will be described with reference to FIG. 8.

FIG. 8 is an explanatory diagram for describing an example of a weighting parameter prepared for each time. FIG. 8 shows an example of converting time-series data of an acceleration of a leg of the user acquired by the sensor apparatus S attached to the leg into time-series data of a velocity v of the leg.

For example, when the user performs a movement of a kick, the sensor apparatus S acquires time-series data before the kick, during the kick, and after the kick. When there is a feature in the movement of the kick when retrieving motion data, the user may set the weighting parameter in the time sections before the kick and after the kick to a small weighting parameter or to 0.

For example, the user may set the weighting parameter wm for each time using the operation display unit 110 included in the information processing terminal 10. For example, when the hatched section in FIG. 8 is a time section where a movement of a kick had been performed by the user, the user may set the weighting parameter wm that acquires a feature amount of the hatched section for each time.

When the hatched section is referred to as an adopted section and a section other than the adopted section is referred to as a non-adopted section, a weighting parameter wmₜ for each time may be set using Expression 1 below.

$${wm}_{t} = 1 / L ( adopted section ) \qquad ( Expression 1 )$$

$${wm}_{t} = 0 ( non - adopted section )$$

$$\sum {wm}_{t} = 1$$

Note that L in Expression 1 denotes a time length of the adopted section.

By using Expression 1 as the weighting parameter wmₜ set for each time with respect to the preprocessing feature amount for each time, for example, the feature amount calculating unit 135 can calculate a feature amount of the time section in which the user had performed a movement of a kick as a post-processing feature amount.

Next, an example of calculating a post-processing feature amount using a weighting parameter wmⱼ set for each region will be described.

For example, when retrieving motion data of performing a kick movement, the user may set a weighting parameter wm_{Leg} with respect to the kicked-up leg larger than the weighting parameter wmⱼ of other regions.

In addition, the weighting parameter wm may be set by the user by using the operation display unit 110 or may be automatically set by the feature amount calculating unit 135. For example, when a moving region is assumed to be important, the feature amount calculating unit 135 may set a large weighting parameter wmⱼ for a region where a magnitude of velocity or a variation in velocity is equal to or larger than a predetermined value and set a small weighting parameter wmⱼ for a region where a magnitude of velocity or a variation in velocity is smaller than the predetermined value.

Furthermore, in addition to learning a relationship between time-series data of skeleton data and a preprocessing feature amount, the learning unit 243 may also learn a relationship between the preprocessing feature amount and the weighting parameter wm.

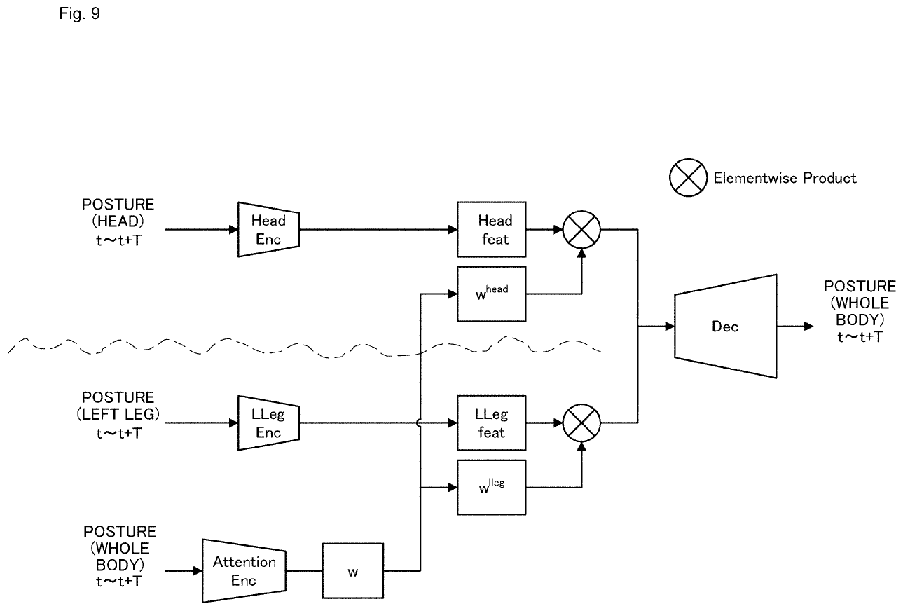

FIG. 9 is an explanatory diagram for describing an example of a learning method of a weighting parameter. The learning unit 243 learns a relationship between a posture of each region of skeleton data and a preprocessing feature amount of each region in the time sections t to t+T using the calculation method of a preprocessing feature amount described with reference to FIG. 6.

Furthermore, the learning unit 243 may input a posture of the entire body and a posture of each region of the skeleton data in the time sections t to t+T and learn a relationship between a preprocessing feature amount of each portion and a weighting parameter of each portion using an attention of a DNN. In a similar manner, the learning unit 243 may input a posture of the entire body and a posture of each region of the skeleton data and learn a relationship between a preprocessing feature amount for each time and a weighting parameter for each time using an attention of a DNN. In this case, the feature amount calculating unit 235 determines a weighting parameter for each time and a weighting parameter for each region using the estimator 247 obtained by learning.

### 3-4. Similarity Evaluation

The information processing terminal 10 transmits information on a post-processing feature amount to the server 20. In addition, the similarity evaluating unit 239 included in the server 20 evaluates a similarity between the received post-processing feature amount and a feature amount of motion data held in the motion feature amount storage unit 225.

The similarity evaluating unit 239 may perform a similarity evaluation using, for example, square errors. For example, with respect to a time section t in a region j, let ^{query}f^{j}_{t,m} denote a preprocessing feature amount of a dimension m, ^{dataset}f^{j}_{t,m} denote a feature amount of motion data, w^{j}_{t,m} denote a weighting parameter, and s denote similarity. In this case, the similarity evaluating unit 239 evaluates a similarity between the post-processing feature amount and the feature amount of motion data using Expression 2.

$$1 / s = {\sum }_{j , t , m} {{w}^{j}}_{t , m} ( {}^{query} {f}_{t , m}^{J} - {}^{dataset} {f}_{t , m}^{J} ) \qquad ( Expression 2 )$$

In addition, the similarity evaluating unit 239 may perform a similarity evaluation using, for example, a correlation coefficient. More specifically, the similarity evaluating unit 239 evaluates a similarity between the post-processing feature amount and the feature amount of motion data using Expression 3.

$$s = {\sum }_{j , m} \{ ( {\sum }_{t , m}^{j} {}^{query} {f}_{t , m}^{J} - {}^{dataset} {f}_{t , m}^{J} ) / ( {\vert {}^{query} {f}_{m}^{J} \vert}_{2} \times {\vert {}^{dataset} {f}_{m}^{J} \vert}_{2} ) \} \qquad ( Expression 3 )$$

In addition, the server 20 transmits motion data in accordance with a result of the similarity evaluation by the similarity evaluating unit 239 to the information processing terminal 10. For example, the similarity evaluating unit 239 may calculate a similarity between the received post-processing feature amount and a feature amount of each of the plurality of pieces of motion data and the server 20 may transmit a predetermined number of pieces of motion data in a descending order of similarity as a retrieval result to the information processing terminal 10.

Furthermore, the user may perform an operation of removing motion data with high similarity from a retrieval result. In this case, motion data of which similarity evaluated by the similarity evaluating unit 239 is equal to or higher than a predetermined value is excluded from the retrieval result.

### 3-5. Correction

In motion data acquired in accordance with a similarity evaluation, motion of an entire body of the user or motion of a region of the user of which a weighting parameter has been increased may be motion that is particularly required by the user. On the other hand, motions of all regions in the motion data do not necessarily coincide with or are not necessarily similar to motions required by the user.

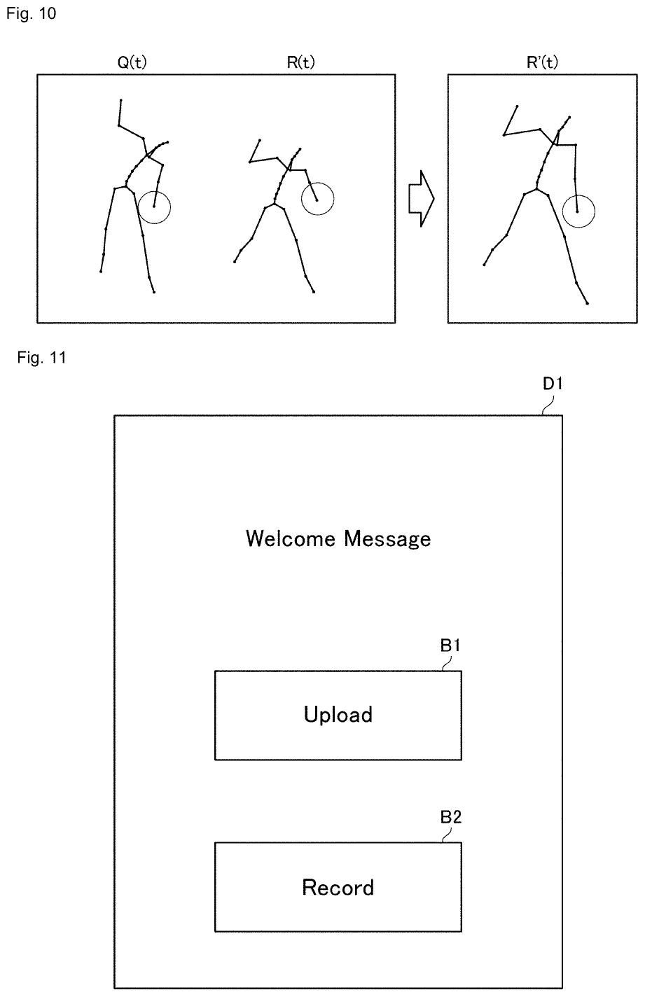

In consideration thereof, the correcting unit 143 may execute processing of correcting a feature amount of motion data acquired as a retrieval result with respect to at least one or more regions of the motion data. Hereinafter, an example of processing of correcting a feature amount of motion data will be described with reference to FIG. 10.

FIG. 10 is an explanatory diagram for describing an example of processing of correcting a feature amount of motion data. In FIG. 10, skeleton data indicating motion of the user acquired by the sensor apparatus S is assumed to be a query Q(t) and skeleton data of motion data acquired as a retrieval result is assumed to be a retrieval result R(t).

For example, when the user wishes to correct a position and a motion of the left hand in the retrieval result R(t) to a position and a motion in the query Q(t), the correcting unit 143 may execute processing of correcting the retrieval result based on a setting ratio having been set by the user using the operation display unit 110.

For example, the correcting unit 143 executes processing of correcting a feature amount of motion data received as a retrieval result from the server 20 by mixing a post-processing feature amount with the feature amount of motion data with respect to at least one or more region of the motion data. Accordingly, the correcting unit 143 acquires a corrected retrieval result R′(t) in which the query Q(t) and the retrieval result R(t) have been mixed.

In addition, the correcting unit 143 may correct a region designated as a correction object by the user so as to move to a same position as the position in the query Q(t).

For example, the correcting unit 143 may execute correction processing using IK so that, with a posture of the retrieval result R(t) as an initial value, a position of a distal region of the retrieval result R(t) coincides with a position in the query Q(t). Since there is a possibility that positions of the hip may deviate between the query Q(t) and the retrieval result R(t) when correcting a position of a region, for example, the correcting unit 143 may execute correction processing based on a relative position from the hip.

Furthermore, for example, the region to be corrected may be designated by the user using the operation display unit 110 or automatically designated by the correcting unit 143.

When the region to be corrected is to be automatically designated by the correcting unit 143, for example, the correcting unit 143 may determine the region to be corrected based on a weighting parameter prepared for each region. For example, the correcting unit 143 may adopt a feature amount of the retrieval result R(t) with respect to a region of which the weighting parameter satisfies a predetermined criterion and execute processing of correcting to the post-processing feature amount of the query Q(t) with respect to a region of which the weighting parameter does not satisfy the predetermined criterion.

Even when the user sets a setting ratio of a post-processing feature amount of the query Q(t) to a feature amount of the of the retrieval result R(t) on an UI, there may be cases where the correcting unit 143 need not execute correction processing based on the setting ratio. For example, when applying the setting ratio disrupts a balance of the entire body in motion data, the correcting unit 143 may execute processing of correcting feature amounts of a region and other regions according to a positional relationship among the respective regions.

This concludes the description of details of processing according to the present disclosure. Next, specific examples of a user interface according to the present disclosure will be described. While first example to fifth example will be hereinafter described in order, any one of the first example to fifth example may be applied or a plurality of examples may be applied in combination as the user interface according to the present disclosure.

In addition, while an example in which the information processing system according to the present disclosure is utilized by a user for the purpose of improving dance skills will be mainly described below, a utilization example of the information processing system according to the present disclosure is not limited to the example. For example, the information processing system according to the present disclosure may be utilized to improve skills in sports such as figure skating.

### 4. USER INTERFACE

### 4-1. First Example

FIG. 11 is an explanatory diagram for describing an example of a data collection screen D1. First, due to an operation by the user, the operation display unit 110 included in the information processing terminal 10 displays the data collection screen D1 on a browser or on an application.

For example, the data collection screen D1 may include an upload button B1 and a record button B2 as shown in FIG. 11. In addition, the data collection screen D1 may include messages to the user such as “Welcome” and “Select one of the buttons below”.

For example, when the user selects the upload button B1 using the operation display unit 110, time-series data such as a video acquired in advance by the user can be uploaded. In addition, when the user selects the record button B2 using the operation display unit 110, time-series data such as a video can be recorded in real-time.

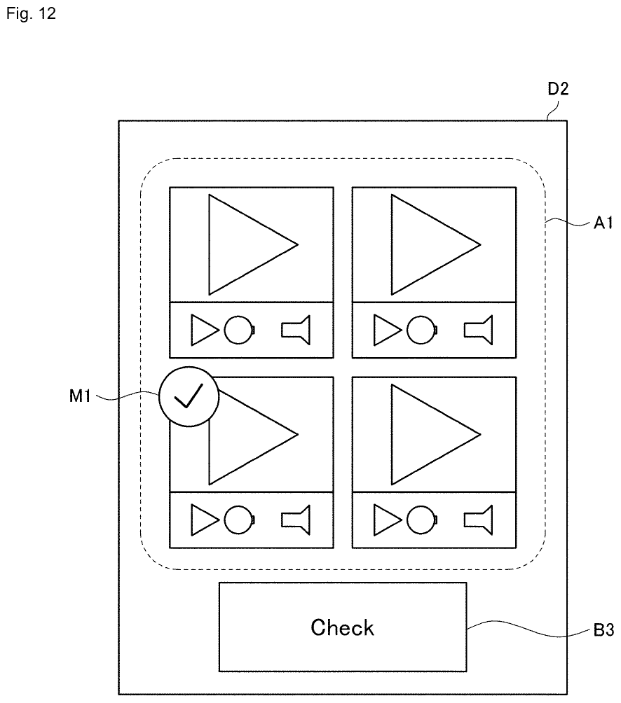

FIG. 12 is an explanatory diagram for describing an example of an upload screen D2. The upload screen D2 shown in FIG. 12 is an example of a screen that is displayed after the upload button B1 shown in FIG. 11 is selected.

For example, the user registers time-series data (for example, video data) that the user wishes to upload on the operation display unit 110. For example, the user may register the time-series data based on any operation such as drag and drop. In doing so, the time-series data to be registered by the user may be a group A1 of a plurality of pieces of time-series data as shown in FIG. 12 or one piece of time-series data.

When the group A1 of a plurality of pieces of time-series data is selected, the user further selects one piece of time-series data M1 on the operation display unit 110 and selects a check button B3. Alternatively, when one piece of time-series data is selected, it can be assumed that the check button B3 has been automatically selected or the user may select the check button B3 after the one piece of time-series data has been registered.

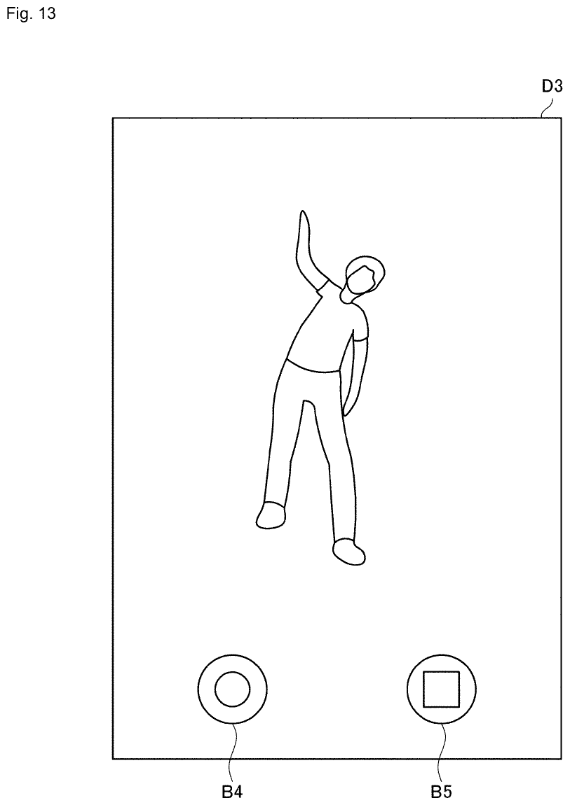

FIG. 13 is an explanatory diagram for describing an example of a record screen D3. The record screen D3 shown in FIG. 13 is an example of a screen that is displayed after the record button B2 shown in FIG. 11 is done.

The record screen D3 may include a record start button B4 and a record stop button B5 as shown in FIG. 13. In addition, the record screen D3 may include a video or the like obtained by photography by a camera included in the information processing terminal 10.

For example, the user selects the record start button B4 on the operation display unit 110. Next, after performing a series of dance motions that the user wishes to practice, the user selects the record stop button B5. As a result, time-series data of a period from the selection of the record start button B4 to the selection of the record stop button B5 is uploaded.

Note that the user can perform dance motions to some kind of music. In this case, the audio acquiring unit 115 may acquire audio from the selection of the record start button B4 to the selection of the record stop button B5.

In addition, while an example where the record screen D3 includes the two buttons of the record start button B4 and the record stop button B5 has been described, the record screen D3 is not limited to this example. For example, the record screen D3 may include one button that includes functions of both the record start button B4 and the record stop button B5. For example, the one button that includes both functions may be a button that alternately realizes the function of the record start button B4 and the function of the record stop button B5 depending on the number of times of selection by the user.

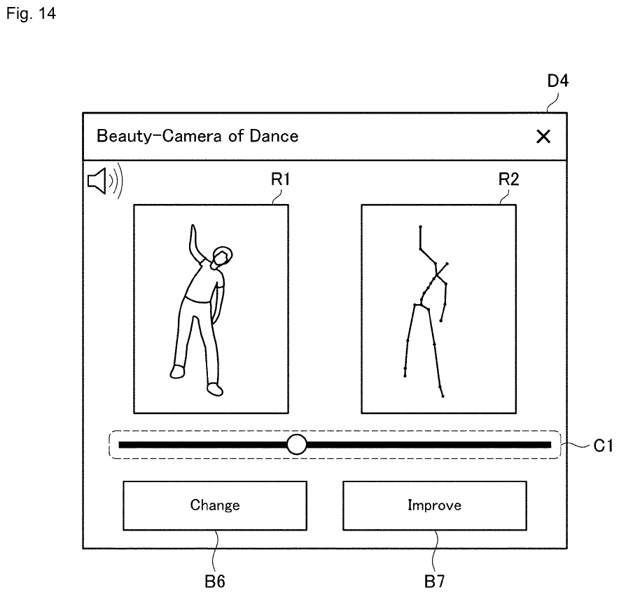

FIG. 14 is an explanatory diagram for describing an example of a confirmation screen D4. The confirmation screen D4 shown in FIG. 14 is an example of a screen that is displayed after the check button B3 shown in FIG. 12 is selected or after the record stop button B5 shown in FIG. 13 is selected.

For example, the confirmation screen D4 may include an actual video R1 as shown in FIG. 14, a generated skeleton video R2 generated based on the actual video R1, a seek bar C1, a change button B6, and an improve button B7.

For example, by moving a cursor included in the seek bar C1, the user can check the actual video R1 and the generated skeleton video R2 of each time of day corresponding to the cursor. For example, when the user determines that a dance motion to be improved is not included, the user may select the change button B6.

For example, when the change button B6 is selected by the user, the operation display unit 110 may once again display the data collection screen D1 shown in FIG. 11 or the upload screen D2 shown in FIG. 12 and prompt the user to collect or register time-series data.

In addition, when the improve button B7 is selected by the user, various kinds of processing related to improvement of a dance motion is executed with the actual video R1 and the generated skeleton video R2 as objects to be improved.

For example, the various kinds of processing related to improvement in this case may include processing of estimating a posture of the user by the posture estimating unit 131, processing of analyzing audio by the audio analyzing unit 132, or processing of dividing time-series data into a plurality of sections by the dividing unit 133.

In addition, the various kinds of processing related to improvement may include processing of retrieving, using the retrieval requesting unit 139, each piece of reference motion data to be a reference of each basic movement included in the plurality of sections divided by the dividing unit 133.

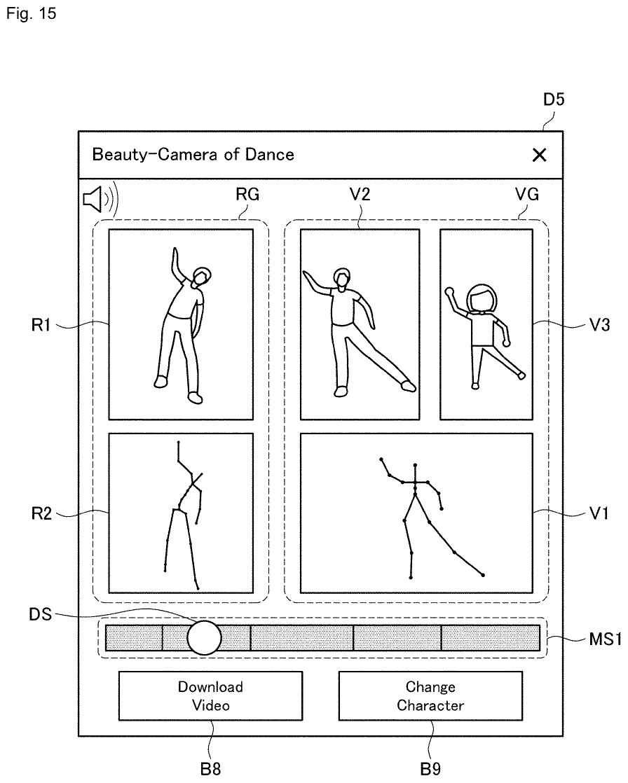

FIG. 15 is an explanatory diagram for describing an example of a result display screen D5. The result display screen D5 shown in FIG. 15 is an example of a screen that is displayed after the improve button B7 shown in FIG. 14 is selected.

The result display screen D5 may include a user video group RG, a reference video group VG, a plurality of sections MS1, a download button B8, and a change character button B9 as shown in FIG. 15.

The user video group RG may include the actual video R1 and the generated skeleton video R2 which are the objects to be improved when the improve button B7 shown in FIG. 14 is selected.

In addition, the reference video group VG is a video group related to reference motion data to be a reference of a basic movement performed by the user. For example, the reference video group VG includes various kinds of video that move in correspondence to the reference motion data.

More specifically, the reference video group VG may include a reference skeleton video V1 indicating a skeleton video that moves in correspondence to the reference motion data, a reference video V2 indicating a video of a user who moves in correspondence to the reference motion data, and a reference character video V3 indicating a video of a predetermined character that moves in correspondence to the reference motion data.

For example, the user designates one section among a plurality of sections MS1 included in time-series data divided by the dividing unit 133. In this case, the section designated by the user will be referred to as a designated section DS.

In addition, the retrieval requesting unit 139 may replace motion data associated with a basic movement included in the designated section DS with reference motion data. For example, the operation display unit 110 may display various kinds of video in which only the designated section DS among the plurality of sections MS1 has been replaced with reference motion data.

As a result, the user can check the user's own motion and a more ideal motion in the designated section while comparing the user video group RG and the reference video group VG and can more readily comprehend areas for improvement in order to enhance dance skills.

In addition, when the user selects the download button B8, the information processing terminal 10 may download a part of or all of the various kinds of videos included in the reference video group VG.

Furthermore, when the user selects the change character button B9, the control unit 130 may change the character of the reference character video V3 included in the reference video group VG. The character may be character data prepared by the user or character data prepared on the server 20 in advance.

This concludes the description of specific examples of the user interface according to the first example. However, the respective screens described with reference to FIGS. 11 to 15 are not limited to the examples described above. For example, the result display screen D5 may include a video obtained by superimposing the generated skeleton video R2 included in the user video group RG and the reference skeleton video V1 included in the reference video group VG shown in FIG. 15 on top of each other. Accordingly, the user can more intuitively comprehend a deviation between a position of each region of the user and an ideal position of the region.

In addition, while an example of the user designating one section among the plurality of sections MS1 has been described, for example, the user may designate two or more sections of a same basic movement. Furthermore, when the user designates one section, the retrieval requesting unit 139 may replace each piece of motion data of two or more sections associated with a basic movement that corresponds to the designated section.

In addition, according to the first example, motion data of a dancer with a high degree of proficiency can be reutilized in advance and the user can practice using motions of an ideal dancer as a reference.

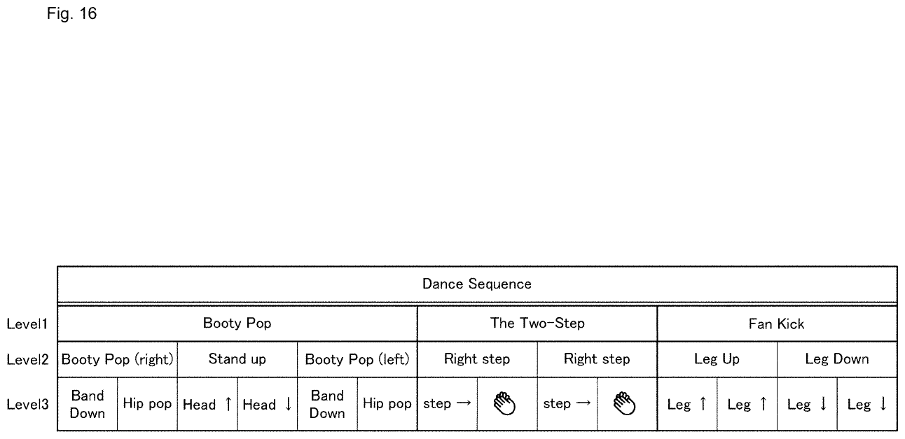

Furthermore, while an example of the dividing unit 133 dividing time-series data into a group of the plurality of sections MS1 has been described, the dividing unit 133 may respectively divide the time-series data into a plurality of sections on a plurality of levels. For example, the dividing unit 133 may divide the time-series data into a plurality of sections on a plurality of levels. Hereinafter, examples of the user interface according to the second example will be described with reference to FIGS. 16 to 18.

### 4-2. Second Example

FIG. 16 is an explanatory diagram for describing an example of a plurality of sections divided by the dividing unit. For example, the dividing unit 133 may divide the time-series data into a plurality of sections on three levels such as Level 1, Level 2, and Level 3 as shown in FIG. 16.

In addition, granularity of a basic movement to be imparted may differ among Level 1, Level 2, and Level 3 as shown in FIG. 16. More specifically, the dividing unit 133 may divide time-series data by setting a finer granularity from Level 1 toward Level 3.

For example, the dividing unit 133 divides time-series data into basic movements such as “Booty Pop” and “The Two Step” on Level 1. In addition, on Level 2, the dividing unit 133 may divide “Booty Pop” on Level 1 into more finely divided basic movements such as “Booty Pop (right)”, “Stand up”, and “Booty Pop (left)”. Furthermore, on Level 3, the dividing unit 133 may further divide “Booty Pop (right)” on Level 2 into more finely divided basic movements such as “Band Down” and “Hip pop”.

In this case, the result display screen D5 shown in FIG. 15 may be a screen that enables the user to select one section included in any of Level 1, Level 2, and Level 3 as a designated section.

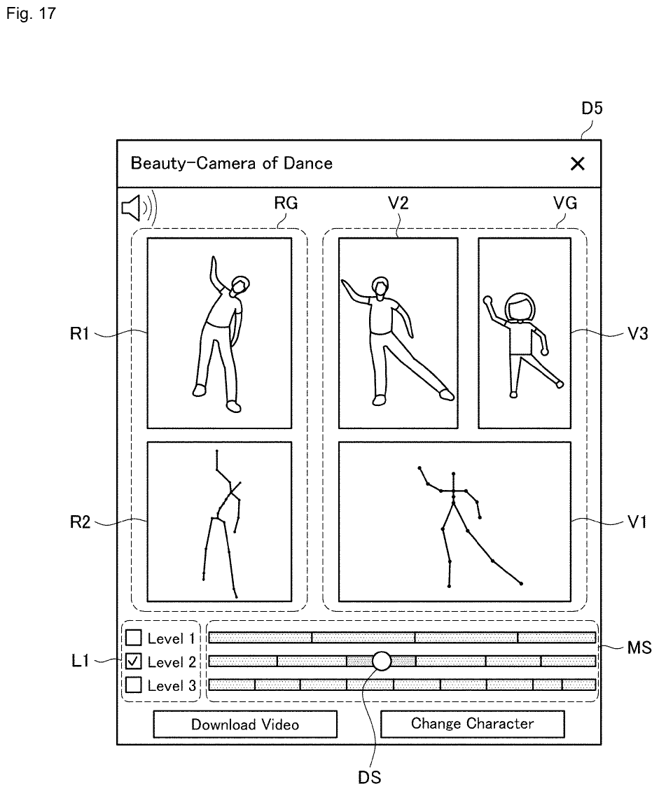

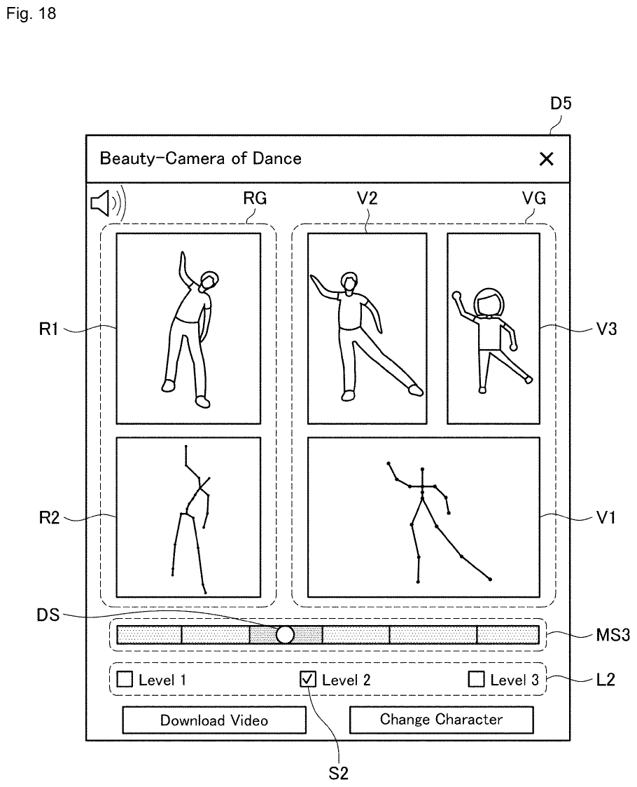

FIGS. 17 and 18 are explanatory diagrams for describing another example of the result display screen D5. For example, as shown in FIG. 17, the result display screen D5 may include a level selection area L1 where one level among a plurality of levels can be selected and a plurality of sections MS2 divided into levels.

In the example shown in FIG. 17, the user selects one level from the level selection area L1. In addition, the user further designates one section from a plurality of sections on the one selected level. Furthermore, the retrieval requesting unit 139 may replace motion data associated with a basic movement included in the designated section DS with reference motion data on the level selected by the user.

In addition, the result display screen D5 may include a level selection area L2 and a plurality of sections MS3 of a level S2 selected from the level selection area L2 as shown in FIG. 18.

In the example shown in FIG. 18, when the user selects the one level S2 from the level selection area L2, the operation display unit 110 displays the plurality of sections MS3 on the level S2 selected by the user. In addition, the user further designates one section from the plurality of sections MS3 being displayed. Furthermore, the retrieval requesting unit 139 may replace motion data associated with a basic movement included in the designated section DS with reference motion data on the level S2 selected by the user.

According to the second example described above, since a section including a basic movement having been broken down on various levels can be selected, the user can practice a basic movement that more closely conforms to the user's requirements.

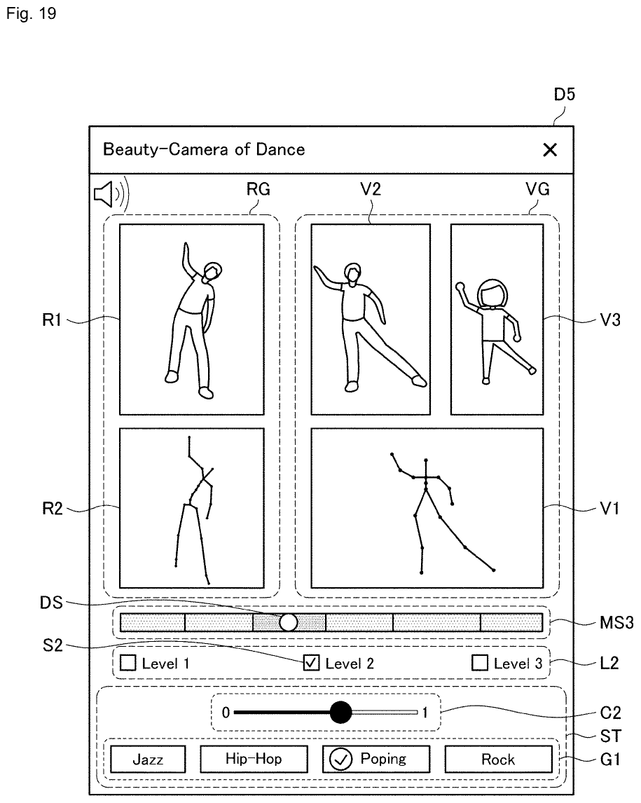

In addition, with dance motions, a direction or a speed in which each region moves can vary depending on genres or styles of music or motions of the user such as jazz and hip-hop even when a movement is the same. In consideration thereof, the retrieval requesting unit 139 may retrieve reference motion data based on a genre of music or motions of the user designated by the user and replace motion of the user included in a designated section with reference motion data based on the genre. Hereinafter, examples of the user interface according to the third example will be described with reference to FIG. 19.

### 4-3. Third Example

FIG. 19 is an explanatory diagram for describing an example of the result display screen D5 according to the third example. For example, the result display screen D5 may further include a genre setting area ST in addition to the level selection area L2 and the plurality of sections M3 shown in FIG. 18.

For example, as shown in FIG. 19, the genre setting area ST may include a genre designating field G1 and a detail setting bar C2.

For example, the genre designating field G1 is a designating field that enables a genre of music or a motion of the user such as “Jazz” or “Hip-hop” as shown in FIG. 19 to be designated. For example, the user can select one genre included in the genre designating field G1.

The detail setting bar C2 is a car including a cursor for setting a contribution rate of a genre designated by the user. For example, the detail setting bar C2 may be configured such that the closer the cursor is to 1, the contribution rate of the genre designated by the user increases, and the closer the cursor is to 0, the contribution rate of the genre decreases.

More specifically, when the user selects the genre of Poping, reference motion data that is closer to the genre of Poping (or in which features of the genre of Poping are more enhanced) may be retrieved as the cursor of the detail setting bar C2 approaches 1.

In addition, the correcting unit 143 may execute correction processing by increasing a setting ratio of a feature amount of reference motion data based on the genre as the detail setting bar C2 approaches 1.

While an example where the result display screen D5 includes the genre setting area ST has been described as the example shown in FIG. 19, other screens may be included. For example, the confirmation screen D4 shown in FIG. 14 may include the genre setting area ST.

According to the third example described above, a motion of the user can be replaced with reference motion data including a feature or motion that can vary according to a genre or a style that the user wishes to practice and the user can check more ideal dance motions.

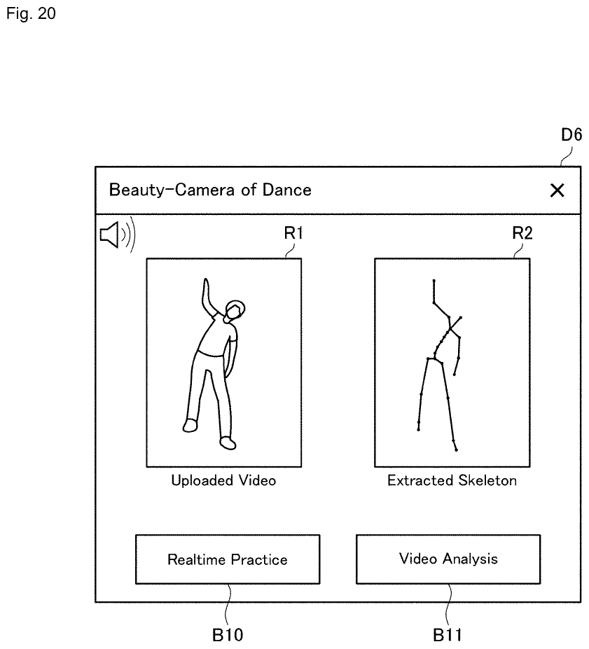

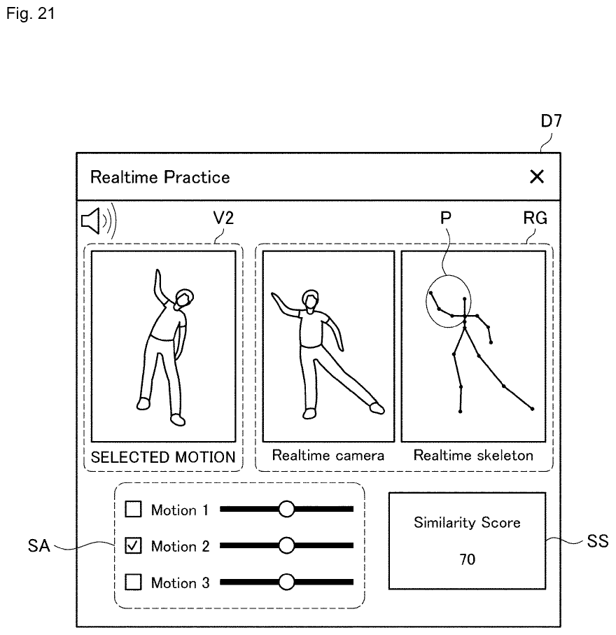

In addition, in improving dance motions, demands for presenting the reference video group VG as shown in FIG. 15 to the user through a wide variety of presentation methods are envisaged. Hereinafter, examples of the user interface according to the fourth example will be described with reference to FIGS. 20 and 21.

### 4-4. Fourth Example

FIG. 20 is an explanatory diagram for describing an example of a setting screen D6 for a presentation method to a user. For example, the presentation method setting screen D6 may be an example of a screen that is displayed after the improve button B7 is selected by the user on the confirmation screen D4 shown in FIG. 14 and before the result display screen D5 is displayed.

For example, the presentation method setting screen D6 may include a real-time practice button B10 and a video analysis button B11.

The real-time practice button B10 is a button that is selected when, for example, the user is to practice a dance motion in real time.

In addition, the video analysis button B11 is a button that is selected when, for example, analyzing video data recorded in advance.

For example, when the video analysis button B11 is selected, the user can practice ideal dancing on a result display screen such as those described above in the first to third examples.

Furthermore, demands of users for practicing in real time while using reference motion data as a reference can be envisaged. Hereinafter, an example of a practice screen that is displayed when the real-time practice button B10 is selected will be described with reference to FIG. 21.

FIG. 21 is an explanatory diagram for describing an example of a practice screen D7 that is displayed when the real-time practice button B10 is selected by the user. The practice screen D7 may include the user video group RG that are real-time videos of the user, a selection field SA of a basic movement, and the reference video V2 corresponding to reference motion data of performing a basic movement selected by the user in the basic movement selection field SA. In this case, for example, a basic movement may include Motion 1, Motion 2, and Motion 3 and may correspond to a plurality of sections divided by the dividing unit 133 described above.

For example, when the user selects Motion 2, the reference video V2 corresponding to reference motion data of performing the selected Motion 2 is repetitively displayed. In addition, a playback position of the reference video V2 may be changed using a seek bar included in the motion selection field SA.

In addition, the user performs a movement of Motion 2 so as to match the reference video V2 performing Motion 2 that is repetitively displayed. Furthermore, the operation display unit 110 may display an evaluation result SS of similarity having been evaluated by the similarity evaluating unit 239.

Note that the similarity evaluation result SS may be an average value, a maximum value, or a minimum value of a similarity between a feature amount of a motion of the user included in real-time video of the user when Motion 2 is being repetitively performed and each feature amount of the reference motion data.

Furthermore, the operation display unit 110 may further display emphasized information P that emphasizes a region of which deviation is large (in other words, a region of which similarity is small) between each region of the user performing Motion 2 and each region of the reference video V2.

In addition, when the video analysis button B11 shown in FIG. 20 is selected, the operation display unit 110 may display an analysis result screen similar to the practice screen D7 shown in FIG. 21. For example, on the analysis result display screen, the user video group RG may include video data uploaded by the user instead of real-time video of the user.

According to the fourth example described above, the user can not only analyze a dance motion by the user using time-series data acquired in advance but can also practice in real time while performing analysis. As a result, the information processing terminal 10 can further improve convenience of the user when practicing a dance motion.

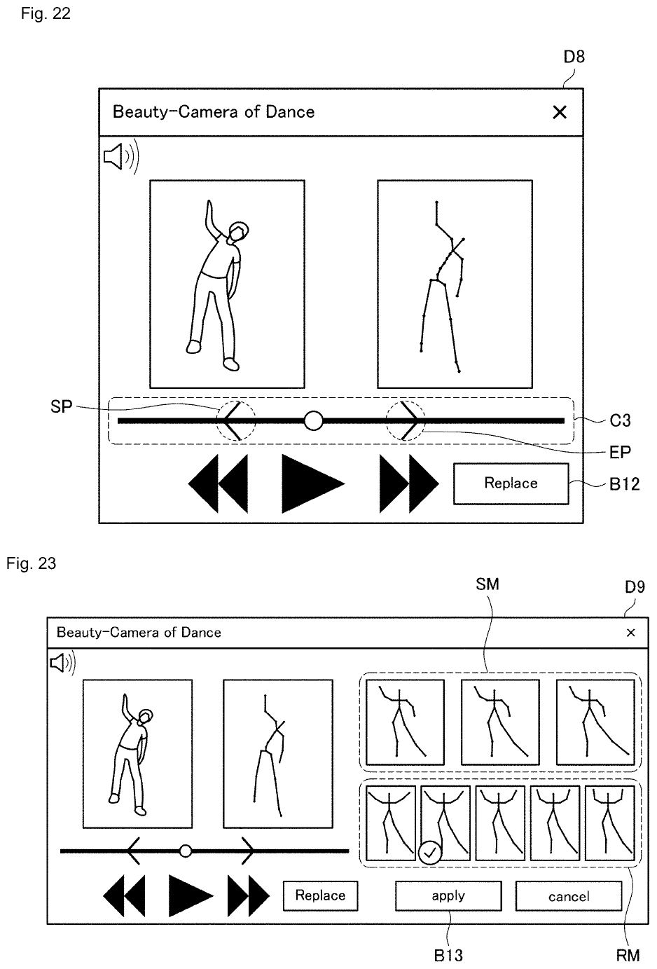

An example where the retrieval requesting unit 139 replaces a motion of the user included in a designated section among sections including a basic movement divided by the dividing unit 133 with reference motion data has been described above. On the other hand, as the designated section, the user may manually adjust a section instead of designating a section divided by the dividing unit 133. Hereinafter, examples of the user interface according to the fourth example will be described with reference to FIGS. 22 and 23.

### 4-5. Fifth Example

FIG. 22 is an explanatory diagram for describing an example of a manual screen for manually designating a designated section. A manual screen D8 is an example of a screen that is displayed when a section where reference motion data is to be retrieved is manually designated by the user.

First, using the operation display unit 110, the user may manually designate the designated section using a retrieval section designation bar C3. For example, the user designates a start point SP of the section to be designated by an operation of the operation display unit 110. Next, the user designates an end point EP of the section to be designated by an operation of the operation display unit 110 and selects a replace button B12.

When the replace button B12 is selected, by adopting the section from the start point SP to the end point EP as the designated section, motion data associated with a basic movement included in the designated section may be replaced with reference motion data.

In addition, when during replacement of the reference motion data, the operation display unit 110 may display a predetermined number of pieces of motion data based on a result of a similarity evaluation as candidates of reference motion data to be replaced.

FIG. 23 is an explanatory diagram for describing an example of a candidate display screen of reference motion data. A candidate display screen D9 is an explanatory diagram for describing an example of a screen that is displayed after the replace button B12 shown in FIG. 22 is selected.

For example, the operation display unit 110 may display a similar motion data group SM indicating a predetermined number of pieces of motion data in a descending order of similarity evaluation as candidates of reference motion data corresponding to a basic movement of the user.

In addition, the operation display unit 110 may display a related motion data group RM indicating pieces of motion data related to motion of the user included in the designated section as candidates of reference motion data. In this case, for example, the related motion data group RM may include particularly difficult movements among movements related to motion of the user.

Furthermore, when the motion data storage unit 221 holds a plurality of pieces of motion data of a same basic movement, the related motion data group RM may include a plurality of pieces of motion data corresponding to the basic movement of the user.

More specifically, when the motion data storage unit 221 holds motion data of a same basic movement such as “Booty Pop” of each of a plurality of users with a high degree of proficiency, the related motion data group RM may include respective pieces of motion data obtained from different users for a same basic movement.

In addition, the user may designate one piece of motion data from the similar motion data group SM or the related motion data group RM, select an apply button B13, and subsequently make a transition to a result display screen including the designated reference motion data.

Furthermore, the user may designate one section among respective sections divided by the dividing unit 133 and the user may further manually adjust the designated section. In this case, the retrieval requesting unit 139 may replace motion data included in a user-designated section indicating a section after a range of the designated section has been adjusted by the user with retrieval reference motion data to be a reference of a basic movement included in the user-designated section.

In addition, when the start point SP and the end point EP shown in FIG. 22 are brought to within a certain distance from a boundary position of a section including a basic movement divided by the dividing unit 133 by an operation by the user, the start point SP and the end point EP may be automatically attracted to the boundary position. Accordingly, the hassle of manual adjustment when designating a section can be reduced and convenience of the user can be further improved.

According to the fifth example described above, the user can finely adjust a designated section and the retrieval requesting unit 139 can replace a motion of the user included in the designated section with reference motion data that more closely conforms to the user's requirements.

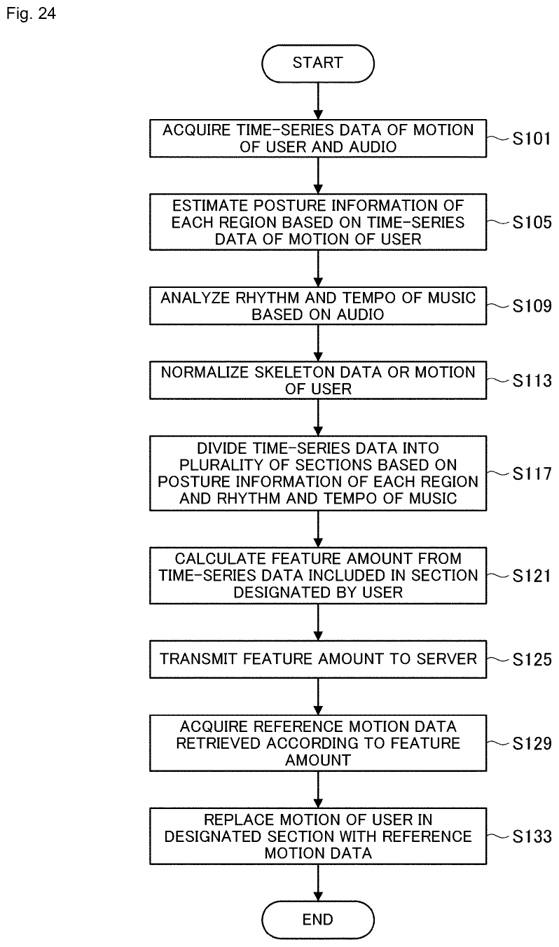

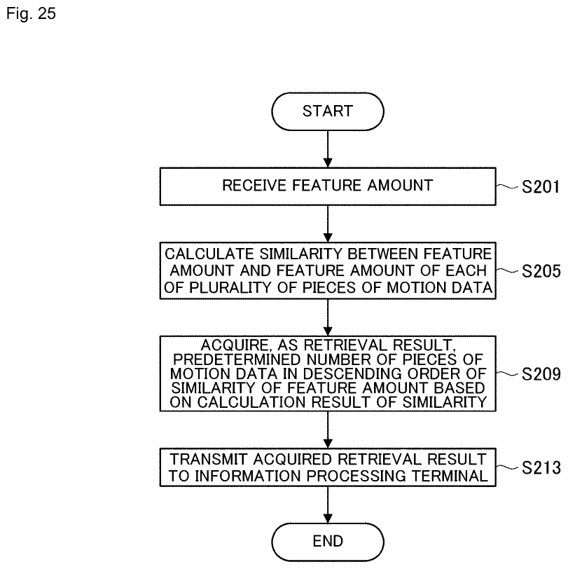

This concludes the description of specific examples of user interfaces according to the present disclosure. Next, specific examples of operation processing of the information processing system according to the present disclosure will be described with reference to FIGS. 24 and 25.

### 5. OPERATION EXAMPLES

### 5-1. Operation Example of Information Processing Terminal

FIG. 24 is an explanatory diagram for describing an operation processing example related to replacing motion data of the information processing terminal 10 according to the present disclosure.

As shown in FIG. 24, the information processing terminal 10 acquires time-series data of motion of the user and audio from the sensor apparatuses S (S101).

Next, the posture estimating unit 131 generates skeleton data as posture information of each region from the acquired time-series data of motion of the object (S105).

Next, the audio analyzing unit 132 analyses rhythm and tempo of music based on the acquired audio (S109).

In addition, the posture estimating unit 131 executes normalization processing of converting a skeleton of each region of the generated skeleton data into a reference skeleton (S113). In doing so, the posture estimating unit 131 may normalize motion of the user based on the analyzed rhythm and tempo of the music.

Based on the posture information of each region and the rhythm and tempo of music, the dividing unit 133 imparts meta-information to the time-series data and divides the time-series data into a plurality of sections based on the imparted meta-information (S117).

In addition, based on the time-series data included in a section designated by the user, the feature amount calculating unit 135 calculates a feature amount of each region of the normalized skeleton data (S121).

Next, the retrieval requesting unit 139 transmits the calculated feature amounts to the server 20 from the communicating unit 120 (S125).

The communicating unit 120 receives reference motion data retrieved in accordance with the feature amounts (S129).

Subsequently, the retrieval requesting unit 139 converts motion data of the designated section with reference motion data (S133) and the information processing terminal 10 according to the present disclosure ends the operation processing related to the replacement of motion data.

Next, an example of operation processing related to retrieval of motion data of the server 20 between S125 and S129 will be described.

### 5-2. Operation Example of Server

FIG. 25 is an explanatory diagram for describing an operation processing example related to retrieval of motion data of the server 20 according to the present disclosure.

First, the communicating unit 210 receives a feature amount from the information processing terminal 10 (S201).

Next, the similarity evaluating unit 239 calculates a similarity between the received feature amount and a feature amount of each of the plurality of pieces of motion data held in the motion feature amount storage unit 225 (S205).

In addition, the similarity evaluating unit 239 acquires a predetermined number of pieces of motion data in a descending order of similarity as a retrieval result (S209).

Furthermore, the communicating unit 210 transmits the predetermined number of pieces of motion data acquired in S209 as a retrieval result to the information processing terminal 10 (S213) and the server 20 ends the operation processing related to the retrieval of motion data.

### 6. HARDWARE CONFIGURATION EXAMPLE

The embodiment of the present disclosure has been described above. Information processing such as processing of dividing time-series data into sections for each basic movement and processing of calculating a feature amount are implemented by cooperation between software and the hardware of the information processing terminal 10, which will be described below. The following hardware configuration is also applicable to the server 20.

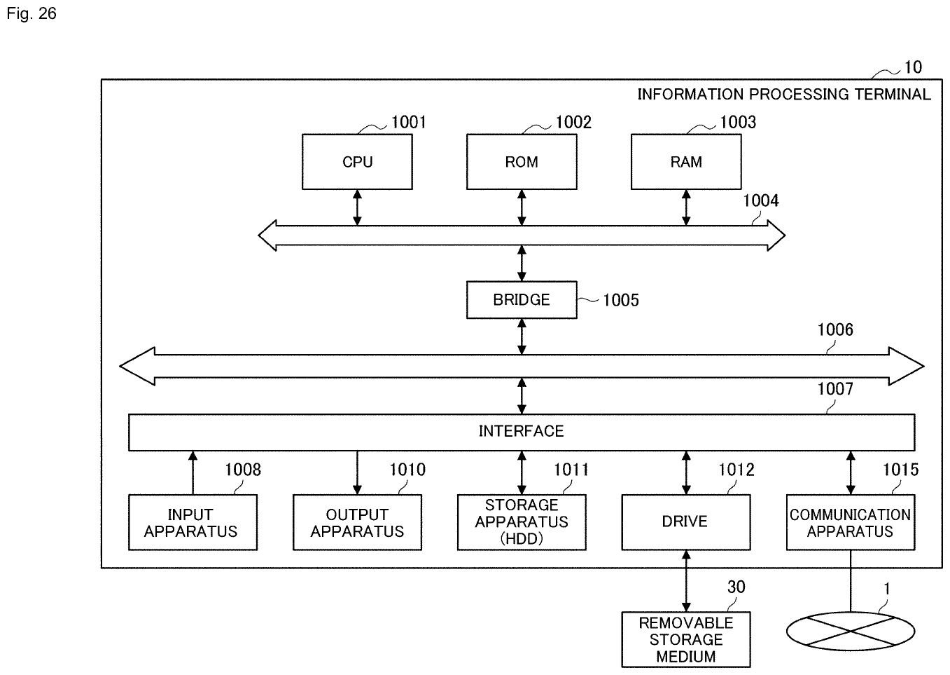

FIG. 26 is a block diagram showing the hardware configuration of the information processing terminal 10. The information processing terminal 10 includes a CPU (Central Processing Unit) 1001, a ROM (Read Only Memory) 1002, a RAM (Random Access Memory) 1003, and a host bus 1004. The information processing terminal 10 further includes a bridge 1005, an external bus 1006, an interface 1007, an input apparatus 1008, an output apparatus 1010, a storage apparatus (HDD) 1011, a drive 1012, and a communication apparatus 1015.

The CPU 1001 acts as an arithmetic processing unit and a controller and controls all operations in the information processing terminal 10 in accordance with various programs. The CPU 1001 may be a microprocessor. The ROM 1002 stores a program, an arithmetic parameter, and the like used by the CPU 1001. The RAM 1003 temporarily stores a program used in execution by the CPU 1001 or a parameter or the like that is appropriately changed during execution of the program. These units are connected to one other via the host bus 1004 constituted of a CPU bus or the like. Cooperation between the CPU 1001, the ROM 1002, the RAM 1003, and software enables the functions of the posture estimating unit 131, the dividing unit 133, the feature amount calculating unit 135, and the like having been described with reference to FIG. 2 to be implemented.

The host bus 1004 is connected to the external bus 1006 such as a PCI (Peripheral Component Interconnect/Interface) bus via the bridge 1005. The host bus 1004, the bridge 1005, and the external bus 1006 need not necessarily be separated from one another and, alternatively, these functions may be implemented on a single bus.

The input apparatus 1008 is constituted of input means used by a user to input information such as a mouse, a keyboard, a touch panel, a button, a microphone, a switch, and a lever and an input control circuit for generating an input signal based on a user input and outputting the signal to the CPU 1001. A user of the information processing terminal 10 can input various kinds of data or provide an instruction of a processing operation to the information processing terminal 10 by manipulating the input apparatus 1008.

The output apparatus 1010 includes, for example, display apparatuses such as a liquid crystal display apparatus, an OLED apparatus, and a lamp. Furthermore, the output apparatus 1010 includes audio output apparatuses such as speakers and headphones. The output apparatus 1010 outputs, for example, reproduced contents. Specifically, the display apparatus displays various kinds of information including reproduced video data as text or images. The audio output apparatus converts reproduced audio data or the like into audio and outputs the audio.

The storage apparatus 1011 is an apparatus for storing data. The storage apparatus 1011 may include a storage medium, a recording apparatus for recording data on the storage medium, a reading apparatus for reading data from the storage medium, and a deletion apparatus for deleting data recorded on the storage medium. The storage apparatus 1011 is constituted of, for example, an HDD (Hard Disk Drive). The storage apparatus 1011 drives a hard disk and stores a program executed by the CPU 1001 and various kinds of data.

The drive 1012 is a recording medium reader/writer and is built into or externally attached to the information processing terminal 10. The drive 1012 reads information recorded on a mounted removable storage medium 30 that is a magnetic disk, an optical disc, a magneto-optical disc, or a semiconductor memory and outputs the information to the RAM 1003. Furthermore, the drive 1012 can write information on the removable storage medium 30.

The communication apparatus 1015 is, for example, a communication interface constituted of a communication device or the like for connection to a network 12. The communication apparatus 1015 may be a wireless LAN-compatible communication apparatus, an LTE (Long Term Evolution)-compatible communication apparatus, or a wired communication apparatus that performs wired communication.

### 7. SUPPLEMENTS

Although a preferred embodiment of the present disclosure has been described in detail with reference to the accompanying drawings, the present disclosure is not limited to such examples. It is apparent that those having ordinary knowledge in the technical field of the present disclosure could conceive of various modified examples or changed examples within the scope of the technical ideas set forth in the claims, and it should be understood that these examples also naturally fall within the technical scope of the present disclosure.

For example, the information processing terminal 10 may further include all of or a part of the functional components of the server 20 according to the present disclosure. When the information processing terminal 10 includes all of or a part of the functional components of the server 20 according to the present disclosure, the information processing terminal 10 will be capable of executing the series of processing related to retrieval without having to communicate via the network 1. In addition, when the information processing terminal 10 includes a part of the functional components of the server 20 according to the present disclosure, for example, the information processing terminal 10 may receive a plurality of pieces of motion data from the server 20 in advance using communication via the network 1. Furthermore, the information processing terminal 10 may perform a similarity evaluation between a post-processing feature amount calculated by the feature amount calculating unit 135 and the plurality of pieces of motion data having been received from the server 20 in advance and retrieve and replace motion data according to an evaluation result of similarity.

The respective steps related to the processing of the information processing terminal 10 and the server 20 in the present specification need not necessarily be processed in chronological order in the order described in the flowcharts. For example, the steps related to the processing of the information processing terminal 10 and the server 20 may be processed in an order that differs from the order described in the flowcharts.

In addition, a computer program for causing hardware such as the CPU, the ROM, and the RAM built into the information processing terminal 10 to perform the same functions as the respective components of the information processing terminal 10 described above can be also created. Furthermore, a storage medium in which the computer program is stored is also provided.

In addition, the operational effects described in the present specification are merely explanatory or exemplary and are not intended as limiting. That is, the techniques according to the present disclosure may exhibit operational effects which are apparent to those skilled in the art and which differ from the description provided in the present specification in addition to or in place of the operational effects described above.

Furthermore, the following configurations also fall within the technical scope of the present disclosure.
(1)

An information processing apparatus, including:
an acquiring unit configured to acquire a motion data group indicating time-series data of motion of a user;
an imparting unit configured to impart meta-information related to a basic movement in association with motion data with respect to the motion data group acquired by the acquiring unit; and
a replacing unit configured to replace the motion data associated with the meta-information corresponding to a designated section indicating a section designated by the user among the motion data group with reference motion data to be a reference.
(2)

The information processing apparatus according to (1), wherein
the replacing unit is configured to
replace a plurality of pieces of motion data associated with a basic movement of the designated section with the reference motion data by referring to the meta-information.
(3)

The information processing apparatus according to (1) or (2), wherein
the imparting unit is configured to
impart the meta-information with respect to the motion data group based on a position and posture information of each region of the user.
(4)

The information processing apparatus according to any one of (1) to (3), wherein the motion data group includes time-series data of motion of the user who moves to some kind of music.
(5)

The information processing apparatus according to (4), wherein
the acquiring unit is configured to
acquire music information indicating information related to the music, and
the imparting unit is configured to
impart the meta-information with respect to the motion data group based on the music information acquired by the acquiring unit.
(6)

The information processing apparatus according to (5), wherein
the imparting unit is configured to
impart different pieces of meta-information for each level with respect to the motion data group among a plurality of levels.
(7)

The information processing apparatus according to any one of (1) to (6), wherein the plurality of levels differ from one another in a granularity of the basic movement to be imparted.
(8)

The information processing apparatus according to any one of (1) to (7), wherein the replacing unit is configured to
replace the motion data associated with a basic movement that corresponds to the designated section with reference motion data retrieved using a feature amount for each time or for each region of the user calculated from the motion data group included in the designated section.
(9)

The information processing apparatus according to (8), wherein
a weighting parameter prepared for each time or for each region is applied to the feature amount.
(10)

The information processing apparatus according to any one of (1) to (9), wherein
the replacing unit is configured to
replace the motion data associated with a basic movement that corresponds to the designated section with reference motion data based on a genre of the music information or a motion of the user having been designated by the user.
(11)

The information processing apparatus according to (10), wherein
the replacing unit is configured to
replace the motion data associated with a basic movement that corresponds to the designated section with reference motion data based on a contribution rate of the genre set by the user.
(12)

The information processing apparatus according to any one of (1) to (11), further including
a display unit configured to display a video corresponding to the reference motion data.
(13)

The information processing apparatus according to (12), wherein
the acquiring unit is configured to
acquire a video of the user, and
the display unit is configured to
display the video of the user and a video corresponding to the reference motion data.
(14)

The information processing apparatus according to (13), wherein
the display unit is configured to
display any one of a real-time video of the user and a video of the user having been recorded in advance as the video of the user in accordance with a presentation method selected by the user.
(15)

The information processing apparatus according to any one of (1) to (11), wherein
the replacing unit is configured to
replace the motion data associated with a basic movement corresponding to a user-designated section indicating a section after a range of the designated section has been adjusted by the user with the reference motion data.
(16)

An information processing method executed by a computer, including the steps of:
acquiring a motion data group indicating time-series data of motion of a user;
imparting meta-information related to a basic movement in association with motion data with respect to the acquired motion data group; and
replacing the motion data associated with the meta-information corresponding to a designated section indicating a section designated by the user among the motion data group with reference motion data to be a reference.
(17)

A program causing a computer to realize:
an acquiring function of acquiring a motion data group indicating time-series data of motion of a user;
an imparting function of imparting meta-information related to a basic movement in association with motion data with respect to the motion data group acquired by the acquiring function; and
a replacing function of replacing the motion data associated with the meta-information corresponding to a designated section indicating a section designated by the user among the motion data group with reference motion data to be a reference.

### REFERENCE SIGNS LIST

10 Information processing terminal
20 Server
110 Operation display unit
115 Audio acquiring unit
120 Communicating unit
130 Control unit
131 Posture estimating unit
132 Audio analyzing unit
133 Dividing unit
135 Feature amount calculating unit
139 Retrieval requesting unit
143 Correcting unit
210 Communicating unit
220 Storage unit
221 Motion data storage unit
225 Motion feature amount storage unit
230 Control unit
231 Reference skeleton converting unit
235 Feature amount calculating unit
239 Similarity evaluating unit
243 Learning unit
247 Estimator

1. An information processing apparatus, comprising:
an acquiring unit configured to acquire a motion data group indicating time-series data of motion of a user;
an imparting unit configured to impart meta-information related to a basic movement in association with motion data with respect to the motion data group acquired by the acquiring unit; and
a replacing unit configured to replace the motion data associated with the meta-information corresponding to a designated section indicating a section designated by the user among the motion data group with reference motion data to be a reference.

2. The information processing apparatus according to claim 1, wherein
the replacing unit is configured to
replace a plurality of pieces of motion data associated with a basic movement of the designated section with the reference motion data by referring to the meta-information.

3. The information processing apparatus according to claim 2, wherein
the imparting unit is configured to
impart the meta-information with respect to the motion data group based on a position and posture information of each region of the user.

4. The information processing apparatus according to claim, 3, wherein
the motion data group includes time-series data of motion of the user who moves to some kind of music.

5. The information processing apparatus according to claim 4, wherein
the acquiring unit is configured to
acquire music information indicating information related to the music, and
the imparting unit is configured to
impart the meta-information with respect to the motion data group based on the music information acquired by the acquiring unit.

6. The information processing apparatus according to claim 5, wherein
the imparting unit is configured to
impart different pieces of meta-information for each level with respect to the motion data group among a plurality of levels.

7. The information processing apparatus according to claim 6, wherein the plurality of levels differ from one another in a granularity of the basic movement to be imparted.

8. The information processing apparatus according to claim 7, wherein
the replacing unit is configured to
replace the motion data associated with a basic movement that corresponds to the designated section with reference motion data retrieved using a feature amount for each time or for each region of the user calculated from the motion data group included in the designated section.

9. The information processing apparatus according to claim 8, wherein a weighting parameter prepared for each time or for each region is applied to the feature amount.

10. The information processing apparatus according to claim 9, wherein
the replacing unit is configured to
replace the motion data associated with a basic movement that corresponds to the designated section with reference motion data based on a genre of the music information or a motion of the user having been designated by the user.

11. The information processing apparatus according to claim 10, wherein
the replacing unit is configured to
replace the motion data associated with a basic movement that corresponds to the designated section with reference motion data based on a contribution rate of the genre set by the user.

12. The information processing apparatus according to claim 11, further comprising a display unit configured to display a video corresponding to the reference motion data.

13. The information processing apparatus according to claim 12, wherein
the acquiring unit is configured to
acquire a video of the user, and
the display unit is configured to
display the video of the user and a video corresponding to the reference motion data.

14. The information processing apparatus according to claim 13, wherein
the display unit is configured to
display any one of a real-time video of the user and a video of the user having been recorded in advance as the video of the user in accordance with a presentation method selected by the user.

15. The information processing apparatus according to claim 11, wherein
the replacing unit is configured to
replace the motion data associated with a basic movement corresponding to a user-designated section indicating a section after a range of the designated section has been adjusted by the user with the reference motion data.

16. An information processing method executed by a computer, comprising the steps of:
acquiring a motion data group indicating time-series data of motion of a user;
imparting meta-information related to a basic movement in association with motion data with respect to the acquired motion data group; and
replacing the motion data associated with the meta-information corresponding to a designated section indicating a section designated by the user among the motion data group with reference motion data to be a reference.

17. A program causing a computer to realize:
an acquiring function of acquiring a motion data group indicating time-series data of motion of a user;
an imparting function of imparting meta-information related to a basic movement in association with motion data with respect to the motion data group acquired by the acquiring function; and
a replacing function of replacing the motion data associated with the meta-information corresponding to a designated section indicating a section designated by the user among the motion data group with reference motion data to be a reference.
